(19) United States
(12) Patent Application Publication
(10) Pub. No.: US 2025/0035464 A1
(43) Pub. Date: Jan. 30, 2025

(54) STRATEGIES FOR MANAGING MAP CURATION EFFICIENTLY

(71) Applicant: Woven by Toyota, Inc., Tokyo (JP)

(72) Inventors: Jose Felix Ladeia Rodrigues, Sunnyvale, CA (US); Shunsho Kaku, Mountain View, CA (US)

(73) Assignee: Woven by Toyota, Inc., Toyko (JP)

(21) Appl. No.: 18/359,992

(22) Filed: Jul. 27, 2023

(51) Int. Cl. G01C 21/00; G06F 16/29; G06N 5/022

(52) U.S. Cl. CPC G01C 21/3859; G01C 21/3863; G06F 16/29; G06N 5/022

(57) ABSTRACT

System, methods, and other embodiments described herein relate to implementing map curation management strategies. In one embodiment, a method includes receiving map data, using an auto-curation predictive model to update the map data with auto-curated data, and using a manual-curation time predictive model to estimate a manual-curation time and generate a manual-curation heat map based on the map data.

### TECHNICAL FIELD

The subject matter described herein relates, in general, to strategies for managing map curation efficiently, and, more particularly, to managing curation workloads based on determinations of resource requirements for map curation.

### BACKGROUND

Vehicles may be equipped with sensor systems (e.g., cameras, LiDAR) that gather probe traces (e.g., image data, points clouds, odometry data, GPS data) to perform object detection using machine learning models. The machine learning models may output auto-curated maps that contains identifications of objects located within the map (e.g., lane markers, stop signs, curbs, crosswalks). Such auto-curated maps may then be curated by hand, such as to correct curations made by the machine learning model or to construct additional information (e.g., determining a lane intersection layout).

### SUMMARY

In one embodiment, example systems and methods relate to a manner of implementing map curation management strategies.

In one embodiment, a map curation management system is disclosed. The vehicle management system includes one or more processors and a memory communicably coupled to the one or more processors. The memory stores a command module including instructions that when executed by the one or more processors cause the one or more processors to receive map data; use an auto-curation predictive model to update the map data with auto-curated data; and use a manual-curation time predictive model to estimate a manual-curation time and generate a manual-curation heat map based on the map data.

In one embodiment, a non-transitory computer-readable medium including instructions that when executed by one or more processors cause the one or more processors to perform one or more functions is disclosed. The instructions include instructions to receive map data; use an auto-curation predictive model to update the map data with auto-curated data; and use a manual-curation time predictive model to estimate a manual-curation time and generate a manual-curation heat map based on the map data.

In one embodiment, a method for implementing map curation management strategies is disclosed. In one embodiment, the method includes receiving map data; using an auto-curation predictive model to update the map data with auto-curated data; and using a manual-curation time predictive model to estimate a manual-curation time and generate a manual-curation heat map based on the map data.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a map curation management system that is associated with implementing map curation management strategies.

FIG. 3 illustrates one embodiment of the map curation management system of FIG. 2 in a cloud-computing environment.

FIG. 4 illustrates one example of an uncurated map.

FIG. 5 illustrate one example of a curated map.

FIG. 6 illustrate one example of a conceptual method for implementing a predictive model.

FIG. 7 illustrates one example of a method for implementing map curation management strategies.

### DETAILED DESCRIPTION

Systems, methods, and other embodiments associated with implementing map curation management strategies. Semi-autonomous or autonomous vehicles often rely on high-definition maps for safe and efficient operation. In order to construct such maps, one approach is to gather probe traces to form an uncurated map, then annotate the map data using human curators. However, human curation is a slow and labor-intensive process. For example, depending on the complexity of the map data, human curation can take hours to days to cover a few miles.

Accordingly, it is advantageous to assist human curators by using an auto-curation predictive model to mimic human curation as described herein. However, auto-curated maps do not necessarily resolve all the problems of managing map curation efficiently, as the complexity of maps can vary from location to location and usually some degree of human curation is required to finalize a high-definition map. Thus, predictive models are described herein that allow for estimating how the complexity of the maps may affect auto-curation times or manual curation times, the likelihood of requiring manual curation, the presence of map deficiencies that may impair auto-curation or manual-curation, and so on. In addition, an approach is provided for estimating the number of probe traces required to resolve detected map deficiencies. In this manner, the systems and methods described herein allow for efficient curation, such as by allowing the distribution of uncurated map data having similar estimated manual curation times to human curators.

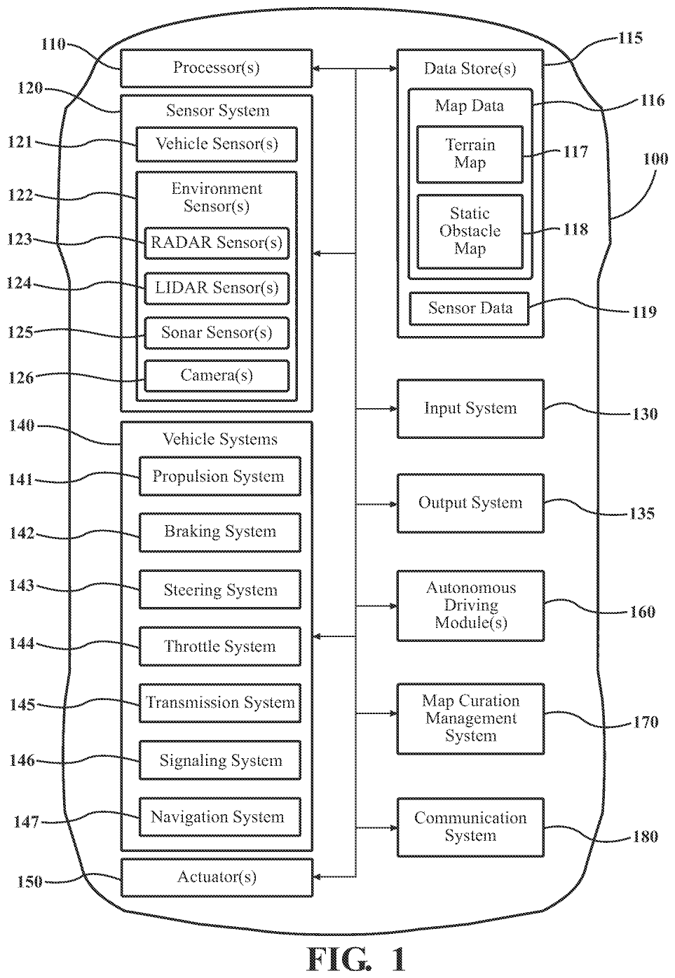

Referring to FIG. 1, an example of a vehicle 100 is illustrated. As used herein, a “vehicle” is any form of motorized transport. In one or more implementations, vehicle 100 is an automobile. While arrangements will be described herein with respect to automobiles, it will be understood that embodiments are not limited to automobiles. In some implementations, vehicle 100 may be any robotic device or form of motorized transport that, for example, includes sensors to perceive aspects of the surrounding environment, and thus benefits from the functionality discussed herein associated with map curation management strategies. As a further note, this disclosure generally discusses vehicle 100 as traveling on a roadway with surrounding vehicles, which are intended to be construed in a similar manner as vehicle 100 itself. That is, the surrounding vehicles may include any vehicle that may be encountered on a roadway by vehicle 100.

Vehicle 100 also includes various elements. It will be understood that in various embodiments it may not be necessary for vehicle 100 to have all of the elements shown in FIG. 1. Vehicle 100 may have any combination of the various elements shown in FIG. 1. Further, vehicle 100 may have additional elements to those shown in FIG. 1. In some arrangements, vehicle 100 may be implemented without one or more of the elements shown in FIG. 1. While the various elements are shown as being located within vehicle 100 in FIG. 1, it will be understood that one or more of these elements may be located external to vehicle 100. Further, the elements shown may be physically separated by large distances. For example, as discussed, one or more components of the disclosed system may be implemented within a vehicle while further components of the system are implemented within a cloud-computing environment or other system that is remote from vehicle 100.

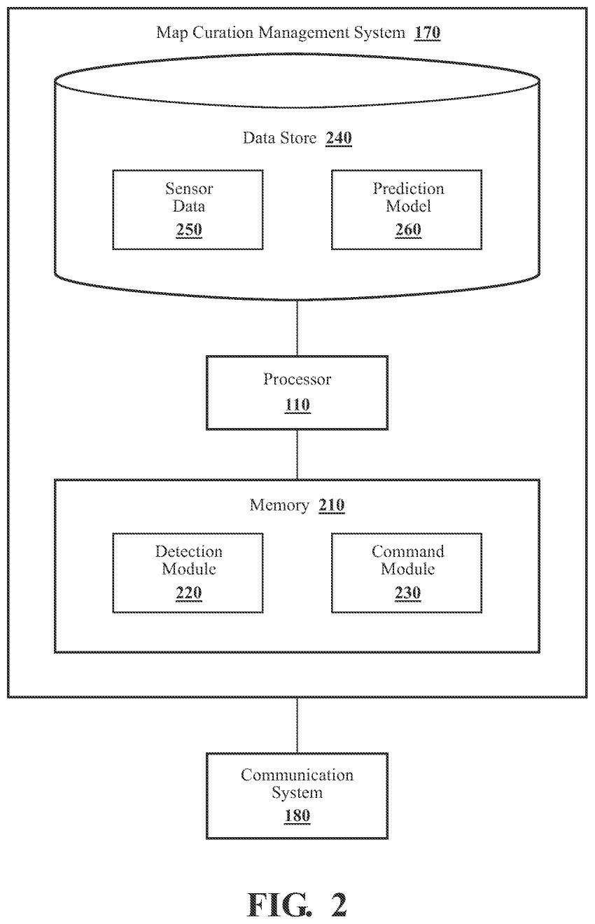

Some of the possible elements of vehicle 100 are shown in FIG. 1 and will be described along with subsequent figures. However, a description of many of the elements in FIG. 1 will be provided after the discussion of FIGS. 2-7 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, vehicle 100 includes a map curation management system 170 that is implemented to perform methods and other functions as disclosed herein relating to implementing map curation management strategies. As will be discussed in greater detail subsequently, map curation management system 170, in various embodiments, is implemented partially within vehicle 100 and as a cloud-based service. For example, in one approach, functionality associated with at least one module of map curation management system 170 is implemented within vehicle 100 while further functionality is implemented within a cloud-based computing system.

With reference to FIG. 2, one embodiment of map curation management system 170 of FIG. 1 is further illustrated. Map curation management system 170 is shown as including processor(s) 110 from vehicle 100 of FIG. 1. Accordingly, processor(s) 110 may be a part of map curation management system 170, map curation management system 170 may include a separate processor from processor 110 (s) of vehicle 100, or map curation management system 170 may access processor 110 (s) through a data bus or another communication path. In one embodiment, map curation management system 170 includes memory 210, which stores detection module 220 and command module 230. Memory 210 is a random-access memory (RAM), read-only memory (ROM), a hard-disk drive, a flash memory, or other suitable memory for storing detection module 220 and command module 230. Detection module 220 and command module 230 are, for example, computer-readable instructions that when executed by processor(s) 110 cause processor(s) 110 to perform the various functions disclosed herein.

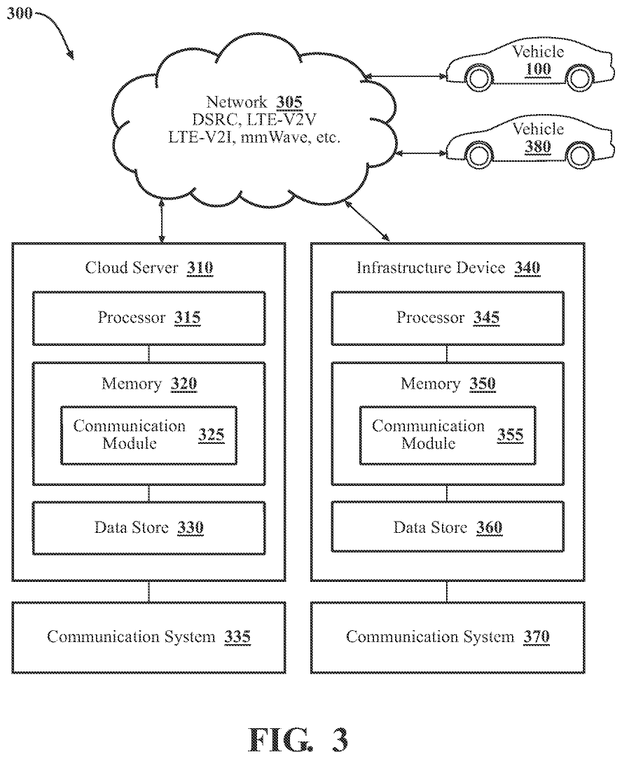

Map curation management system 170 as illustrated in FIG. 2 is generally an abstracted form of map curation management system 170 as may be implemented between vehicle 100 and a cloud-computing environment. FIG. 3, which is further described below, illustrates one example of a cloud-computing environment 300 that may be implemented along with map curation management system 170. As illustrated in FIG. 3, map curation management system 170 may be embodied at least in part within cloud-computing environment 300.

With reference to FIG. 2, detection module 220 generally includes instructions that function to control processor(s) 110 to receive data inputs from one or more sensors of vehicle 100. The inputs are, in one embodiment, observations of one or more objects in an environment proximate to vehicle 100, other aspects about the surroundings, or both. As provided for herein, detection module 220, in one embodiment, acquires sensor data 250 that includes at least camera images. In further arrangements, detection module 220 acquires sensor data 250 from further sensors such as radar 123, LiDAR 124, and other sensors as may be suitable for identifying vehicles, locations of the vehicles, lane markers, crosswalks, traffic signs, vehicle parking areas, road surface types, curbs, vehicle barriers, and so on. In one embodiment, detection module 220 may also acquire sensor data 250 from one or more sensors that allow for implementing map curation management strategies.

Accordingly, detection module 220, in one embodiment, controls the respective sensors to provide sensor data 250. Additionally, while detection module 220 is discussed as controlling the various sensors to provide sensor data 250, in one or more embodiments, detection module 220 may employ other techniques to acquire sensor data 250 that are either active or passive. For example, detection module 220 may passively sniff sensor data 250 from a stream of electronic information provided by the various sensors to further components within vehicle 100. Moreover, detection module 220 may undertake various approaches to fuse data from multiple sensors when providing sensor data 250, from sensor data acquired over a wireless communication link (e.g., v2v) from one or more of the surrounding vehicles, or from a combination thereof. Thus, sensor data 250, in one embodiment, represents a combination of perceptions acquired from multiple sensors.

In addition to locations of surrounding vehicles, sensor data 250 may also include, for example, odometry information, GPS data, or other location data. Moreover, detection module 220, in one embodiment, controls the sensors to acquire sensor data about an area that encompasses 360 degrees about vehicle 100, which may then be stored in sensor data 250. In some embodiments, such area sensor data may be used to provide a comprehensive assessment of the surrounding environment around vehicle 100. Of course, in alternative embodiments, detection module 220 may acquire the sensor data about a forward direction alone when, for example, vehicle 100 is not equipped with further sensors to include additional regions about the vehicle or the additional regions are not scanned due to other reasons (e.g., unnecessary due to known current conditions).

Moreover, in one embodiment, map curation management system 170 includes a database 240. Database 240 is, in one embodiment, an electronic data structure stored in memory 210 or another data store and that is configured with routines that may be executed by processor(s) 110 for analyzing stored data, providing stored data, organizing stored data, and so on. Thus, in one embodiment, database 240 stores data used by the detection module 220 and command module 230 in executing various functions. In one embodiment, database 240 includes sensor data 250 along with, for example, metadata that characterize various aspects of sensor data 250. For example, the metadata may include location coordinates (e.g., longitude and latitude), relative map coordinates or tile identifiers, time/date stamps from when separate sensor data 250 was generated, and so on.

Detection module 220, in one embodiment, is further configured to perform additional tasks beyond controlling the respective sensors to acquire and provide sensor data 250. For example, detection module 220 includes instructions that may cause processor(s) 110 to form a probe trace using data from a visual Simultaneous Localization and Mapping (visual SLAM) system stored in sensor data 250. For example, detection module 220 may include in a probe trace, as vehicle 100 moves from one location to another, any information identifying nearby physical objects along the path of travel based on sensor data 250. Such information may be comprised of timestamps, pose/orientation/location of the camera or vehicle, camera images, keypoints, depth measurements, point cloud data (e.g., from LiDAR 124), remote surveillance data (e.g., from a drone, infrastruction devices, satellite), or other data useful for generating maps based on the probe trace. In some embodiments, the probe trace may also contain localization information such as odometry data, GPS data, or other metrics specifying a relative or absolute distance between physical objects along the path of travel based on sensor data 250. In some embodiments, the probe trace may also contain traffic data, such as the number of road users, the types of road users, the average speed of road users, and so on.

In one embodiment, command module 230 generally includes instructions that function to control the processor(s) 110 or collection of processors in the cloud-computing environment 300 as shown in FIG. 3 for implementing map curation management strategies.

With reference to FIG. 3, vehicle 100 may be connected to a network 305, which allows for communication between vehicle 100 and cloud servers (e.g., cloud server 310), infrastructure devices (e.g., infrastructure device 340), other vehicles (e.g., vehicle 380), and any other systems connected to network 305. With respect to network 305, such a network may use any form of communication or networking to exchange data, including but not limited to the Internet, Directed Short Range Communication (DSRC) service, LTE, 5G, millimeter wave (mmWave) communications, and so on.

Cloud server 310 is shown as including a processor 315 that may be a part of map curation management system 170 through network 305 via communication unit 335. In one embodiment, cloud server 310 includes a memory 320 that stores a communication module 325. Memory 320 is a random-access memory (RAM), read-only memory (ROM), a hard-disk drive, a flash memory, or other suitable memory for storing communication module 325. Communication module 325 is, for example, computer-readable instructions that when executed by processor 315 causes processor 315 to perform the various functions disclosed herein. Moreover, in one embodiment, cloud server 310 includes database 330. Database 330 is, in one embodiment, an electronic data structure stored in a memory 320 or another data store and that is configured with routines that may be executed by processor 315 for analyzing stored data, providing stored data, organizing stored data, and so on.

Infrastructure device 340 is shown as including a processor 345 that may be a part of map curation management system 170 through network 305 via communication unit 370. In one embodiment, infrastructure device 340 includes a memory 350 that stores a communication module 355. Memory 350 is a random-access memory (RAM), read-only memory (ROM), a hard-disk drive, a flash memory, or other suitable memory for storing communication module 355. Communication module 355 is, for example, computer-readable instructions that when executed by processor 345 causes processor 345 to perform the various functions disclosed herein. Moreover, in one embodiment, infrastructure device 340 includes a database 360. Database 360 is, in one embodiment, an electronic data structure stored in memory 350 or another data store and that is configured with routines that may be executed by processor 345 for analyzing stored data, providing stored data, organizing stored data, and so on.

Accordingly, in addition to information obtained from sensor data 250, map curation management system 170 may obtain information from cloud servers (e.g., cloud server 310), infrastructure devices (e.g., infrastructure device 340), other vehicles (e.g., vehicle 380), and any other systems connected to network 305. In some embodiments, cloud server 310 may perform aspects described herein with respect to command module 230.

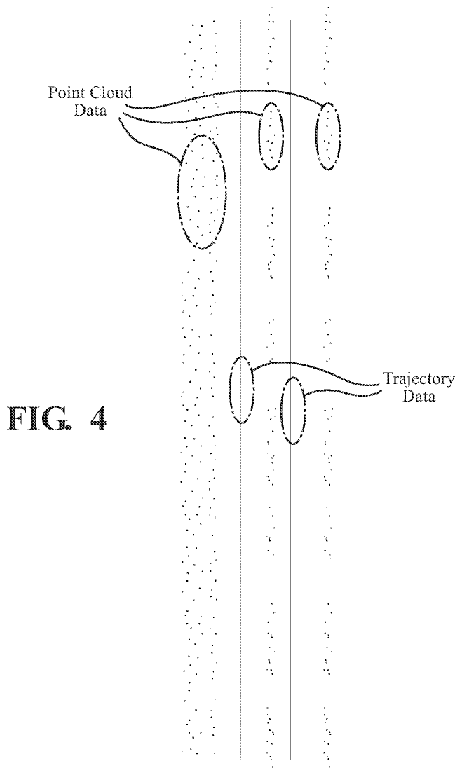

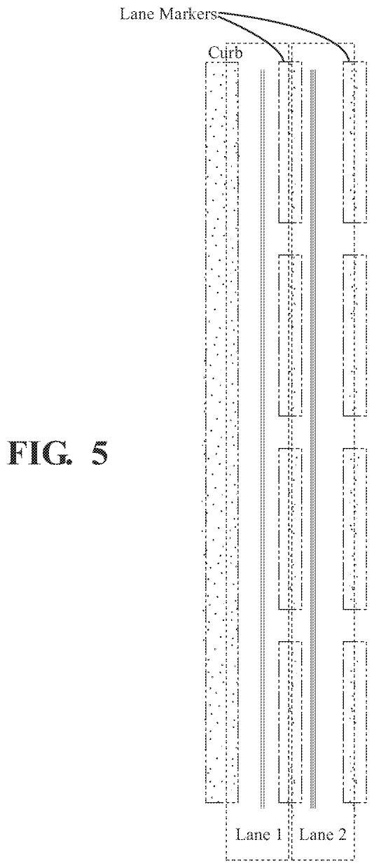

In some embodiments, command module 230 may receive an uncurated map, wherein such a map may include on one or more probe traces. For example, command module 230 may receive an uncurated map containing probe traces containing point cloud information and associated vehicle trajectories as shown in FIG. 4. Upon receiving the uncurated map, command module 230 may generate an auto-curated map as shown in FIG. 5. Command module 230 may use a machine learning model to generate the auto-curated map, such as a convolutional neural network, recurrent neural network, generative adversarial networks, autoencoders, semantic segmentation networks, deep neural network and so on.

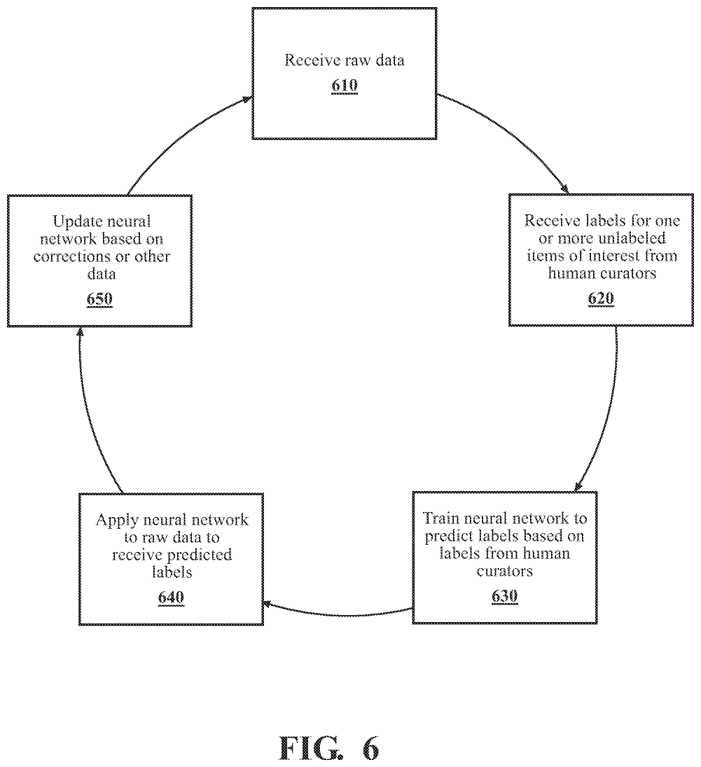

With respect to FIG. 6, a conceptual diagram illustrating a machine learning approach to auto-curated maps is shown. Upon receiving raw data 610 (e.g., from within the uncurated map or Sensor Data 250), command module 230 may initiate a learning stage 620 where human curators select one or more unlabeled items of interest (e.g., lane markers) and label them. Next, command module may use the human-generated labels to initiate a training stage 630, where a neural network may use human-generated labels as training data to create a machine learning model that predicts labels for uncurated maps. Once such a machine learning model is formed, command module 230 may then initiate a deployment stage 640, where such a predictive model is used to predict labels for unlabeled items. Command module 230 may then use an update stage 650 to adjust the predictive model based on the use of groundtruth data, human corrections to predicted labels, or other corrective actions to the predicted labels. In some embodiments, command module 230 may utilize a layered approach to map curation (e.g., identifying individual objects, such as lane markers, then identifying lanes and intersections based on individual objects), which may utilize one or more machine learning models.

In some embodiments, such an auto-curative model as described above may be trained to mimic human curation. For example, based on uncurated map data and logs of human curation, the auto-curative model may be trained to replicate human curation. In some embodiments, an algorithm may divide the uncurated map based on pre-defined criteria, such as criteria that separates uncurated map data into separate segments depending on whether it encompasses an intersection or a connecting road (e.g., intersection segments, road segments). In some embodiments, the segmentation algorithm may also generate segment classification data characterizing the nature of the segment (e.g., three-way intersection, straight road, merge). In some embodiments, in training the auto-curative model, the logs of human curation will be divided in accordance with the map segments when training the auto-curative model. As another example, based on uncurated map data and the final results of human curation, the auto-curative model may be trained to replicate human curation. As above, the uncurated map data and final human curation results may be segmented with respect to pre-defined criteria, which may then also undergo segment classification.

In some embodiments, command module 230 may use one or more neural networks to predict auto-curation time. For example, after a predictive model for auto-curation is created, command module 230 may utilize the inputs to the auto-curation predictive model (e.g., an uncurated map) and the time that is required for the auto-curation predictive model to perform auto-curation as training data for a neural network that predicts auto-curation time. In some embodiments, an auto-curation time predictive model may also generate an auto-curation heat map based on the uncurated map, such as for visualizing predicted auto-curation times. For example, segments of the uncurated map(s) may be submitted to the auto-curation predictive time model to obtain auto-curation times with respect to each segment, after which an auto-curation time predictive model may be trained to predict auto-curation times and generate heat maps based on the map segments and their associated auto-curation times. In some embodiments, the segmentation of the uncurated map may be selected by a human curator, while in other embodiments an algorithm may be used to automatically divide uncurated maps into segments. For example, such an algorithm may divide uncurated maps based on pre-defined criteria, such as criteria that separates uncurated map data into separate segments depending on whether it encompasses an intersection or a connecting road (e.g., intersection segments, road segments). In some embodiments, the segmentation algorithm may also generate segment classification data characterizing the nature of the segment (e.g., three-way intersection, straight road, merge).

In some embodiments, command module 230 may then adjust such segments to equalize auto-curation time, such as where the auto-curation predictive model will be implemented in multiple instances in a distributed computing environment. For example, command module 230 may employ a metric to assess significant deviations between segments in terms of auto-curation time, then adjust map segments by moving boundaries in accordance with the auto-curation heat map. For instance, where a segment may be determined to have an undesirably high auto-curation time (e.g., exceeding a threshold), the boundaries of such a segment may be adjusted inward relative to a neighboring segment in the auto-curation heat map that has a lower auto-curation time. In various embodiments, command module 230 may also use the auto-curation time predictive model to estimate the rate at which the such an uncurated map is likely to be auto-curated (e.g., 6 segments per hour, 10 minutes per kilometer) based on available resources. In some embodiments, the auto-curation time predictive model may provide predictions of total auto-curation time based on an uncurated map.

In some embodiments, command module 230 may also receive metrics associated with human curation of auto-curated maps. For example, such metrics may indicate correction data (e.g., where the auto-curated map was in error or otherwise failed to curate properly); the completion times required to perform manual corrections with respect to any auto-curated map defects; locations in the auto-curated map where a human curator has designed that additional data is required for accurate curation; and so on. In various embodiments, such information may be used to update the auto-curation predictive model, the auto-curation time predictive model, or both.

In some embodiments, command module 230 may use one or more neural networks to predict manual-curation time. For example, command module 230 may utilize an uncurated map, an auto-curated map, or both, along with the corrections data and the completion times associated with the corrections data as training data for a neural network that predicts manual-curation times. In some embodiments, a manual-curation time predictive model may also generate a manual-curation heat map based an uncurated map, an auto-curated map, or both, such as for visualizing predicted manual-curation times. For example, segments from the uncurated map(s), the auto-curated map(s), or both may be submitted to the manual-curation predictive time model to obtain manual-curation times with respect to each segment, after which a manual-curation time predictive model may be trained to predict manual-curation times and generate heat maps based on the map segments and their associated manual-curation times. In some embodiments, the segmentation of an uncurated map or auto-curated may be selected by a human curator, while in other embodiments an algorithm may be used to automatically divide uncurated maps or auto-curated maps into segments. For example, such an algorithm may divide uncurated maps or auto-curated maps based on pre-defined criteria, such as criteria that separates uncurated map data or auto-curated map data into separate segments depending on whether it encompasses an intersection or a connecting road (e.g., intersection segments, road segments). In some embodiments, the segmentation algorithm may also generate segment classification data characterizing the nature of the segment (e.g., three-way intersection, straight road, merge).

In some embodiments, command module 230 may then adjust such segments to equalize manual-curation time, such as where segments of the auto-curated map will be distributed across multiple human curators. For example, command module 230 may employ a metric to assess significant deviations between segments in terms of manual-curation time, then adjust map segments by moving boundaries in accordance with the manual-curation heat map. For instance, where a segment may be determined to have an undesirably high manual-curation time (e.g., exceeding a threshold), the boundaries of such a segment may be adjusted inward relative to a neighboring segment in the manual-curation heat map that has a lower manual-curation time. In various embodiments, command module 230 may also use the manual-curation time predictive model to estimate the rate at which the such an uncurated map is likely to be manual-curated (e.g., 6 segments per week, 4 hours per kilometer) based on available resources (e.g., the available number of human curators). In some embodiments, the manual-curation time predictive model may provide predictions of total manual-curation time based on an uncurated map, an auto-curated map, or both.

In some embodiments, command module 230 may use one or more neural networks to predict the extent of map deficiencies (e.g., where manual curation will likely be required, or insufficient map data is present for accurate curation). For example, command module 230 may utilize an uncurated map, an auto-curated map, and correction data as training data for a neural network that predicts map deficiencies. For example, by dividing the data into segments of similar road or intersection types (e.g., straight road, curved road, two-lane highway, four-way intersection, street-light intersection, etc.), one or more models may be trained to predict the likelihood of manual curation being required based on the amount of uncurated map data provided within that segment. As another example, the one or more models may be trained to predict the likelihood of additional map data being required, such as where manual curation has indicated that such a need exists with respect to a map segment, or an algorithm determines that auto or manual curation has yielded an insufficient level of accuracy.

In some embodiments, the map deficiency model may also provide an estimate of the amount of additional map data required for a map segment such that the likelihood of manual correction satisfies one or more thresholds. For example, an additional probe trace model may be constructed based on probe traces to estimate the amount and type of additional data that would be obtained for an additional probe trace. Such an additional probe trace model may further be trained to provide the amount and type of additional data that would be obtained with respect to segments associated with specific road or intersection types. Command module 230 may then use the map deficiency model to provide an estimated likelihood of manual correction by applying probe trace simulation data provided by the additional probe trace model to an uncurated map. If the resulting estimated likelihood of manual correction fails to satisfy one or more thresholds, command module may repeat the process of generating and applying additional probe trace simulation data to an uncurated map until the one or more thresholds are satisfied.

In some embodiments, such an approach may also provide an estimate of the amount of additional map data required for a map segment such that the estimated manual correction time satisfies one or more thresholds. For example, upon each instance of applying additional probe trace simulation data to an uncurated map, command module 230 may use the manual-curation time predictive model to provide an estimated manual correction time for such a modified map. If the resulting estimated manual correction time fails to satisfy one or more thresholds, command module may repeat the process of generating and applying additional probe trace simulation data to an uncurated map until the one or more thresholds are satisfied.

In some embodiments, command module 230 may generate one or more correction routes for obtaining additional probe traces based on the use of the map deficiency model to determine where additional probe traces should be performed. For example, command module 230 may determine one or more correction routes that are optimized to obtain the desired number of additional probe traces in the shortest amount of time possible, in the shortest amount of distance travelled, or to achieve other goals. For example, in some embodiments, the optimization may take into account the number and location of vehicles that are available to obtain probe traces and construct correction routes to efficiently distribute data collection across the vehicles. In some embodiments, the optimization may also take into account traffic patterns (e.g., to target data collection when vehicle traffic will be sparse), weather data (e.g., to avoid weather that will impair data collection), priority designations assigned to road or intersection types (e.g., a highway interchange may be designated with a higher priority than a four-way stop intersection involving gravel roads, such that the optimization seeks to obtain higher value priority targets first), and so on.

In some embodiments, command module 230 may send or receive correction routes, where each correction route may be constructed to configure a vehicle to follow the correction route and to obtain probe trace data. Upon executing a correction route and receiving the probe trace data, command module 230 may determine if such probe data is sufficient, such as by applying the probe trace data to an uncurated map and using the map deficiency model, the manual-curation time predictive model, or both to see if the likelihood of manual correction, an estimated manual correction time, or both satisfy selected thresholds. If the selected thresholds are not satisfied, command module 230 may determine whether to repeat a segment or continue with the correction route, such as where instructions on whether repetition is allowed was added by command module 230 when generating the correction route.

It should be appreciated that command module 230 in combination with a prediction model 260 may form a computational model such as a machine learning logic, deep learning logic, a neural network model, or another similar approach. In one embodiment, prediction model 260 is a statistical model such as a regression model that may provide an auto-curation predictive model, auto-curation time predictive mode, manual-curation time predictive model, map deficiency model, additional probe trace model, or other models described herein based on sensor data 250 or other sources of information as described herein. Accordingly, predictive model 260 may be a polynomial regression (e.g., least weighted polynomial regression), least squares or another suitable approach.

Moreover, in alternative arrangements, prediction model 260 is a probabilistic approach such as a hidden Markov model. In either case, command module 230, when implemented as a neural network model or another model, in one embodiment, electronically accepts sensor data 250 as an input, which may also include probe trace data. Accordingly, command module 230 in concert with prediction model 260 may produce various determinations/assessments as an electronic output that characterizes the noted aspect as, for example, a single electronic value. Moreover, in further aspects, map curation management system 170 may collect the noted data, log responses, and use the data and responses to subsequently further train predictive model 260.

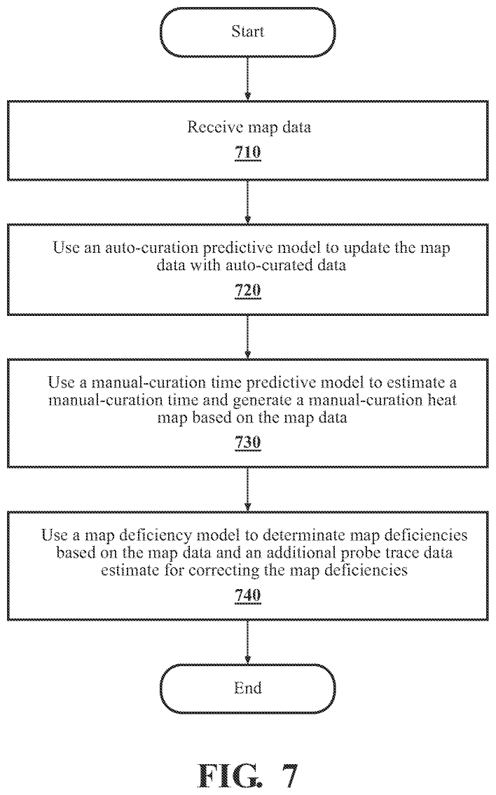

FIG. 7 illustrates a flowchart of a method 700 that is associated with implementing map curation management strategies. Method 700 will be discussed from the perspective of the map curation management system 170 of FIGS. 1 and 2. While method 700 is discussed in combination with the map curation management system 170, it should be appreciated that the method 700 is not limited to being implemented within map curation management system 170 but is instead one example of a system that may implement method 700.

At 710, command module 230 may receive map data. For example, probe traces from vehicle 100 or other vehicles may be stored in sensor data 250. In some embodiments, the map data may be entirely uncurated, while in other embodiments the map data may be partially curated (e.g., due to information provided by a vehicle system, due to a new map being formed from both new uncurated map data and previously curated map data).

At 720, command module 230 may use an auto-curation predictive model to update the map data with auto-curated data. For example, an auto-curative model trained to mimic human curation through a generative adversarial network or other approaches may be used to update the map data with auto-curated data. In some embodiments, if previously curated data is present in the map data the auto-curation predictive model may be configured to generate auto-curated data with or without respect to such previously curated data (e.g., it may ignore it or accept it as properly curated). In some embodiments, if the auto-curation model results in a conflict with the previously curated data, notification may be made such as by displaying a notification to a human curator.

In some embodiments, an algorithm in conjunction with the auto-curative model may divide the map data based on pre-defined criteria, such as criteria that separates the map data into separate segments depending on whether it encompasses an intersection or a connecting road (e.g., intersection segments, road segments). In some embodiments, the segmentation algorithm may also generate segment classification data characterizing the nature of the segment (e.g., three-way intersection, straight road, merge). In some embodiments, command module 230 may then adjust such segments to equalize auto-curation time, such as where the auto-curation predictive model will be implemented in multiple instances in a distributed computing environment.

At 730, command module 230 may use a manual-curation time predictive model to estimate a manual-curation time and generate a manual-curation heat map based on the map data. For example, segments from the map data may be submitted to a manual-curation predictive time model as described herein to obtain manual-curation times with respect to each segment. In some embodiments, the segmentation of the map data may be selected by a human curator, while in other embodiments an algorithm may be used to automatically divide map data into segments. For example, such an algorithm may divide map data based on pre-defined criteria, such as criteria that separates map data into separate segments depending on whether it encompasses an intersection or a connecting road (e.g., intersection segments, road segments). In some embodiments, the segmentation algorithm may also generate segment classification data characterizing the nature of the segment (e.g., three-way intersection, straight road, merge).

In some embodiments, command module 230 may then adjust such segments to equalize manual-curation time, such as where segments of the map data will be distributed across multiple human curators. For example, command module 230 may employ a metric to assess significant deviations between segments in terms of manual-curation time, then adjust map segments by moving boundaries in accordance with the manual-curation heat map. For instance, where a segment may be determined to have an undesirably high manual-curation time (e.g., exceeding a threshold), the boundaries of such a segment may be adjusted inward relative to a neighboring segment in the manual-curation heat map that has a lower manual-curation time.

At 740, command module 230 may use a map deficiency model to determine map deficiencies based on the map data and an additional probe trace data estimate for correcting the map deficiencies. For example, command module 230 may a map deficiency model as described herein to predict the extent of map deficiencies (e.g., where manual curation will likely be required, or insufficient map data is present for accurate curation). In some embodiments, the map deficiency model may also provide an estimate of the amount of additional map data required for a map segment such that the likelihood of manual correction satisfies one or more thresholds. In some embodiments, such an approach may also provide an estimate of the amount of additional map data required for a map segment such that the estimated manual correction time satisfies one or more thresholds. In some embodiments, command module 230 may also generate one or more correction routes for obtaining additional probe traces based on the use of the map deficiency model to determine where additional probe traces should be performed. In some embodiments, command module 230 may send or receive correction routes, where each correction route may be constructed to include route instructions configuring a vehicle to follow the correction route and to obtain probe trace data. Upon executing a correction route and receiving the probe trace data, command module 230 may determine if such probe trace data is sufficient, such as by applying the additional probe trace data to the map data and using the map deficiency model, the manual-curation time predictive model, or both to see if the likelihood of manual correction, an estimated manual correction time, or both satisfy selected thresholds.

FIG. 1 will now be discussed in full detail as an example environment within which the system and methods disclosed herein may operate. In some instances, vehicle 100 is configured to switch selectively between various modes, such as an autonomous mode, one or more semi-autonomous operational modes, a manual mode, etc. Such switching may be implemented in a suitable manner, now known, or later developed. “Manual mode” means that all of or a majority of the navigation/maneuvering of the vehicle is performed according to inputs received from a user (e.g., human driver). In one or more arrangements, vehicle 100 may be a conventional vehicle that is configured to operate in only a manual mode.

In one or more embodiments, vehicle 100 is an autonomous vehicle. As used herein, “autonomous vehicle” refers to a vehicle that operates in an autonomous mode. “Autonomous mode” refers to using one or more computing systems to control vehicle 100, such as providing navigation/maneuvering of vehicle 100 along a travel route, with minimal or no input from a human driver. In one or more embodiments, vehicle 100 is either highly automated or completely automated. In one embodiment, vehicle 100 is configured with one or more semi-autonomous operational modes in which one or more computing systems perform a portion of the navigation/maneuvering of the vehicle along a travel route, and a vehicle operator (i.e., driver) provides inputs to the vehicle to perform a portion of the navigation/maneuvering of vehicle 100 along a travel route.

Vehicle 100 may include one or more processors 110. In one or more arrangements, processor(s) 110 may be a main processor of vehicle 100. For instance, processor(s) 110 may be an electronic control unit (ECU). Vehicle 100 may include one or more data stores 115 for storing one or more types of data. Data store(s) 115 may include volatile memory, non-volatile memory, or both. Examples of suitable data store(s) 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. Data store(s) 115 may be a component of processor(s) 110, or data store 115 may be operatively connected to processor(s) 110 for use thereby. The term “operatively connected,” as used throughout this description, may include direct or indirect connections, including connections without direct physical contact.

In one or more arrangements, data store(s) 115 may include map data 116. Map data 116 may include maps of one or more geographic areas. In some instances, map data 116 may include information or data on roads, traffic control devices, road markings, structures, features, landmarks, or any combination thereof in the one or more geographic areas. Map data 116 may be in any suitable form. In some instances, map data 116 may include aerial views of an area. In some instances, map data 116 may include ground views of an area, including 360-degree ground views. Map data 116 may include measurements, dimensions, distances, information, or any combination thereof for one or more items included in map data 116. Map data 116 may also include measurements, dimensions, distances, information, or any combination thereof relative to other items included in map data 116. Map data 116 may include a digital map with information about road geometry. Map data 116 may be high quality, highly detailed, or both.

In one or more arrangements, map data 116 may include one or more terrain maps 117. Terrain map(s) 117 may include information about the ground, terrain, roads, surfaces, other features, or any combination thereof of one or more geographic areas. Terrain map(s) 117 may include elevation data in the one or more geographic areas. Terrain map(s) 117 may be high quality, highly detailed, or both. Terrain map(s) 117 may define one or more ground surfaces, which may include paved roads, unpaved roads, land, and other things that define a ground surface.

In one or more arrangements, map data 116 may include one or more static obstacle maps 118. Static obstacle map(s) 118 may include information about one or more static obstacles located within one or more geographic areas. A “static obstacle” is a physical object whose position does not change or substantially change over a period of time and whose size does not change or substantially change over a period of time. Examples of static obstacles include trees, buildings, curbs, fences, railings, medians, utility poles, statues, monuments, signs, benches, furniture, mailboxes, large rocks, hills. The static obstacles may be objects that extend above ground level. The one or more static obstacles included in static obstacle map(s) 118 may have location data, size data, dimension data, material data, other data, or any combination thereof, associated with it. Static obstacle map(s) 118 may include measurements, dimensions, distances, information, or any combination thereof for one or more static obstacles. Static obstacle map(s) 118 may be high quality, highly detailed, or both. Static obstacle map(s) 118 may be updated to reflect changes within a mapped area.

Data store(s) 115 may include sensor data 119. In this context, “sensor data” means any information about the sensors that vehicle 100 is equipped with, including the capabilities and other information about such sensors. As will be explained below, vehicle 100 may include sensor system 120. Sensor data 119 may relate to one or more sensors of sensor system 120. As an example, in one or more arrangements, sensor data 119 may include information on one or more LIDAR sensors 124 of sensor system 120.

In some instances, at least a portion of map data 116 or sensor data 119 may be located in data stores(s) 115 located onboard vehicle 100. Alternatively, or in addition, at least a portion of map data 116 or sensor data 119 may be located in data stores(s) 115 that are located remotely from vehicle 100.

As noted above, vehicle 100 may include sensor system 120. Sensor system 120 may include one or more sensors. “Sensor” means any device, component, or system that may detect or sense something. The one or more sensors may be configured to sense, detect, or perform both in real-time. As used herein, the term “real-time” means a level of processing responsiveness that a user or system senses as sufficiently immediate for a particular process or determination to be made, or that enables the processor to keep up with some external process.

In arrangements in which sensor system 120 includes a plurality of sensors, the sensors may work independently from each other. Alternatively, two or more of the sensors may work in combination with each other. In such an embodiment, the two or more sensors may form a sensor network. Sensor system 120, the one or more sensors, or both may be operatively connected to processor(s) 110, data store(s) 115, another element of vehicle 100 (including any of the elements shown in FIG. 1), or any combination thereof. Sensor system 120 may acquire data of at least a portion of the external environment of vehicle 100 (e.g., nearby vehicles).

Sensor system 120 may include any suitable type of sensor. Various examples of different types of sensors will be described herein. However, it will be understood that the embodiments are not limited to the particular sensors described. Sensor system 120 may include one or more vehicle sensors 121. Vehicle sensor(s) 121 may detect, determine, sense, or acquire in a combination thereof information about vehicle 100 itself. In one or more arrangements, vehicle sensor(s) 121 may be configured to detect, sense, or acquire in a combination thereof position and orientation changes of vehicle 100, such as, for example, based on inertial acceleration. In one or more arrangements, vehicle sensor(s) 121 may include one or more accelerometers, one or more gyroscopes, an inertial measurement unit (IMU), a dead-reckoning system, a global navigation satellite system (GNSS), a global positioning system (GPS), a navigation system 147, other suitable sensors, or any combination thereof. Vehicle sensor(s) 121 may be configured to detect, sense, or acquire in a combination thereof one or more characteristics of vehicle 100. In one or more arrangements, vehicle sensor(s) 121 may include a speedometer to determine a current speed of vehicle 100.

Alternatively, or in addition, sensor system 120 may include one or more environment sensors 122 configured to acquire, sense, or acquire in a combination thereof driving environment data. “Driving environment data” includes data or information about the external environment in which an autonomous vehicle is located or one or more portions thereof. For example, environment sensor(s) 122 may be configured to detect, quantify, sense, or acquire in any combination thereof obstacles in at least a portion of the external environment of vehicle 100, information/data about such obstacles, or a combination thereof. Such obstacles may be comprised of stationary objects, dynamic objects, or a combination thereof. Environment sensor(s) 122 may be configured to detect, measure, quantify, sense, or acquire in any combination thereof other things in the external environment of vehicle 100, such as, for example, lane markers, signs, traffic lights, traffic signs, lane lines, crosswalks, curbs proximate to vehicle 100, off-road objects, etc.

Various examples of sensors of sensor system 120 will be described herein. The example sensors may be part of the one or more environment sensor(s) 122, the one or more vehicle sensors 121, or both. However, it will be understood that the embodiments are not limited to the particular sensors described.

As an example, in one or more arrangements, sensor system 120 may include one or more radar sensors 123, one or more LIDAR sensors 124, one or more sonar sensors 125, one or more cameras 126, or any combination thereof. In one or more arrangements, camera(s) 126 may be high dynamic range (HDR) cameras or infrared (IR) cameras.

Vehicle 100 may include an input system 130. An “input system” includes any device, component, system, element or arrangement or groups thereof that enable information/data to be entered into a machine. Input system 130 may receive an input from a vehicle passenger (e.g., a driver or a passenger). Vehicle 100 may include an output system 135. An “output system” includes any device, component, or arrangement or groups thereof that enable information/data to be presented to a vehicle passenger (e.g., a person, a vehicle passenger, etc.).

Vehicle 100 may include one or more vehicle systems 140. Various examples of vehicle system(s) 140 are shown in FIG. 1. However, vehicle 100 may include more, fewer, or different vehicle systems. It should be appreciated that although particular vehicle systems are separately defined, each or any of the systems or portions thereof may be otherwise combined or segregated via hardware, software, or a combination thereof within vehicle 100. Vehicle 100 may include a propulsion system 141, a braking system 142, a steering system 143, throttle system 144, a transmission system 145, a signaling system 146, a navigation system 147, other systems, or any combination thereof. Each of these systems may include one or more devices, components, or combinations thereof, now known or later developed.

Navigation system 147 may include one or more devices, applications, or combinations thereof, now known or later developed, configured to determine the geographic location of the vehicle 100, to determine a travel route for vehicle 100, or to determine both. Navigation system 147 may include one or more mapping applications to determine a travel route for vehicle 100. Navigation system 147 may include a global positioning system, a local positioning system, a geolocation system, or any combination thereof.

Processor(s) 110, map curation management system 170, automated driving module(s) 160, or any combination thereof may be operatively connected to communicate with various aspects of vehicle system(s) 140 or individual components thereof. For example, returning to FIG. 1, processor(s) 110, automated driving module(s) 160, or a combination thereof may be in communication to send or receive information from various aspects of vehicle system(s) 140 to control the movement, speed, maneuvering, heading, direction, etc. of vehicle 100. Processor(s) 110, map curation management system 170, automated driving module(s) 160, or any combination thereof may control some or all of these vehicle system(s) 140 and, thus, may be partially or fully autonomous.

Processor(s) 110, map curation management system 170, automated driving module(s) 160, or any combination thereof may be operable to control at least one of the navigation or maneuvering of vehicle 100 by controlling one or more of vehicle systems 140 or components thereof. For instance, when operating in an autonomous mode, processor(s) 110, map curation management system 170, automated driving module(s) 160, or any combination thereof may control the direction, speed, or both of vehicle 100. Processor(s) 110, map curation management system 170, automated driving module(s) 160, or any combination thereof may cause vehicle 100 to accelerate (e.g., by increasing the supply of fuel provided to the engine), decelerate (e.g., by decreasing the supply of fuel to the engine, by applying brakes), change direction (e.g., by turning the front two wheels), or perform any combination thereof. As used herein, “cause” or “causing” means to make, force, compel, direct, command, instruct, enable, or in any combination thereof an event or action to occur or at least be in a state where such event or action may occur, either in a direct or indirect manner.

Vehicle 100 may include one or more actuators 150. Actuator(s) 150 may be any element or combination of elements operable to modify, adjust, alter, or in any combination thereof one or more of vehicle systems 140 or components thereof to responsive to receiving signals or other inputs from processor(s) 110, automated driving module(s) 160, or a combination thereof. Any suitable actuator may be used. For instance, actuator(s) 150 may include motors, pneumatic actuators, hydraulic pistons, relays, solenoids, and piezoelectric actuators, just to name a few possibilities.

Vehicle 100 may include one or more modules, at least some of which are described herein. The modules may be implemented as computer-readable program code that, when executed by processor(s) 110, implement one or more of the various processes described herein. One or more of the modules may be a component of processor(s) 110, or one or more of the modules may be executed on or distributed among other processing systems to which processor(s) 110 is operatively connected. The modules may include instructions (e.g., program logic) executable by processor(s) 110. Alternatively, or in addition, data store(s) 115 may contain such instructions.

In one or more arrangements, one or more of the modules described herein may include artificial or computational intelligence elements, e.g., neural network, fuzzy logic, or other machine learning algorithms. Further, in one or more arrangements, one or more of the modules may be distributed among a plurality of the modules described herein. In one or more arrangements, two or more of the modules described herein may be combined into a single module.

Vehicle 100 may include one or more autonomous driving modules 160. Automated driving module(s) 160 may be configured to receive data from sensor system 120 or any other type of system capable of capturing information relating to vehicle 100, the external environment of the vehicle 100, or a combination thereof. In one or more arrangements, automated driving module(s) 160 may use such data to generate one or more driving scene models. Automated driving module(s) 160 may determine position and velocity of vehicle 100. Automated driving module(s) 160 may determine the location of obstacles, obstacles, or other environmental features including traffic signs, trees, shrubs, neighboring vehicles, pedestrians, etc.

Automated driving module(s) 160 may be configured to receive, determine, or in a combination thereof location information for obstacles within the external environment of vehicle 100, which may be used by processor(s) 110, one or more of the modules described herein, or any combination thereof to estimate: a position or orientation of vehicle 100; a vehicle position or orientation in global coordinates based on signals from a plurality of satellites or other geolocation systems; or any other data/signals that could be used to determine a position or orientation of vehicle 100 with respect to its environment for use in either creating a map or determining the position of vehicle 100 in respect to map data.

Automated driving module(s) 160 either independently or in combination with map curation management system 170 may be configured to determine travel path(s), current autonomous driving maneuvers for vehicle 100, future autonomous driving maneuvers, modifications to current autonomous driving maneuvers, etc. Such determinations by automated driving module(s) 160 may be based on data acquired by sensor system 120, driving scene models, data from any other suitable source such as determinations from sensor data 250, or any combination thereof. In general, automated driving module(s) 160 may function to implement different levels of automation, including advanced driving assistance (ADAS) functions, semi-autonomous functions, and fully autonomous functions. “Driving maneuver” means one or more actions that affect the movement of a vehicle. Examples of driving maneuvers include accelerating, decelerating, braking, turning, moving in a lateral direction of vehicle 100, changing travel lanes, merging into a travel lane, and reversing, just to name a few possibilities. Automated driving module(s) 160 may be configured to implement driving maneuvers. Automated driving module(s) 160 may cause, directly or indirectly, such autonomous driving maneuvers to be implemented. As used herein, “cause” or “causing” means to make, command, instruct, enable, or in any combination thereof an event or action to occur or at least be in a state where such event or action may occur, either in a direct or indirect manner. Automated driving module(s) 160 may be configured to execute various vehicle functions, whether individually or in combination, to transmit data to, receive data from, interact with, or to control vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-7, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, or processes described above may be realized in hardware or a combination of hardware and software and may be realized in a centralized fashion in one processing system or in a distributed fashion where different elements are spread across several interconnected processing systems. Any kind of processing system or another apparatus adapted for carrying out the methods described herein is suited. A typical combination of hardware and software may be a processing system with computer-usable program code that, when being loaded and executed, controls the processing system such that it carries out the methods described herein. The systems, components, or processes also may be embedded in a computer-readable storage, such as a computer program product or other data programs storage device, readable by a machine, tangibly embodying a program of instructions executable by the machine to perform methods and processes described herein. These elements also may be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that may contain or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein may be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory communicably coupled to the processor and storing machine-readable instructions that, when executed by the processor, cause the processor to:
receive map data;
use an auto-curation predictive model to update the map data with auto-curated data; and
use a manual-curation time predictive model to estimate a manual-curation time and generate a manual-curation heat map based on the map data.

2. The system of claim 1, wherein the machine-readable instruction to use the manual-curation time predictive model further includes to divide the map data into segments and to adjust two or more segments to change a set of manual-curation times associated with the two or more segments.

3. The system of claim 1, wherein the machine-readable instructions further includes an instruction to use an auto-curation time predictive model to estimate an auto-curation time and generate an auto-curation heat map based on the map data.

4. The system of claim 3, wherein the machine-readable instruction to use the auto-curation time predictive model further includes to divide the map data into segments and to adjust two or more segments to change a set of auto-curation times associated with the two or more segments.

5. The system of claim 1, wherein the machine-readable instructions further includes an instruction to use a map deficiency model to determine map deficiencies based on the map data and an additional probe trace data estimate for correcting the map deficiencies.

6. The system of claim 5, wherein the machine-readable instructions further includes instructions to determine a correction route based on the additional probe trace data estimate; and to send the correction route to a vehicle, wherein the correction route includes route instructions that configures the vehicle to implement the correction route.

7. The system of claim 5, wherein the machine-readable instructions further includes instructions to obtain additional probe data; and to determine if map deficiencies have been resolved based on the additional probe data.

8. A non-transitory computer-readable medium including instructions that when executed by one or more processors cause the one or more processors to:
receive map data;
use an auto-curation predictive model to update the map data with auto-curated data; and
use a manual-curation time predictive model to estimate a manual-curation time and
generate a manual-curation heat map based on the map data.

9. The non-transitory computer-readable medium of claim 8, wherein instruction to use the manual-curation time predictive model further includes to divide the map data into segments and to adjust two or more segments to change a set of manual-curation times associated with the two or more segments.

10. The non-transitory computer-readable medium of claim 8, wherein the instructions further includes an instruction to use an auto-curation time predictive model to estimate an auto-curation time and generate an auto-curation heat map based on the map data.

11. The non-transitory computer-readable medium of claim 10, wherein the instruction to use the auto-curation time predictive model further includes to divide the map data into segments and to adjust two or more segments to change a set of auto-curation times associated with the two or more segments.

12. The non-transitory computer-readable medium of claim 8, wherein the instructions further includes an instruction to use a map deficiency model to determine map deficiencies based on the map data and an additional probe trace data estimate for correcting the map deficiencies.

13. The non-transitory computer-readable medium of claim 12, wherein the instructions further includes instructions to determine a correction route based on the additional probe trace data estimate; and to send the correction route to a vehicle, wherein the correction route includes route instructions that configures the vehicle to implement the correction route.

14. A method, comprising:
receiving map data;
using an auto-curation predictive model to update the map data with auto-curated data; and
using a manual-curation time predictive model to estimate a manual-curation time and generate a manual-curation heat map based on the map data.

15. The method of claim 14, wherein using the manual-curation time predictive model further includes dividing the map data into segments and adjusting two or more segments to change a set of manual-curation times associated with the two or more segments.

16. The method of claim 14, further comprising using an auto-curation time predictive model to estimate an auto-curation time and generate an auto-curation heat map based on the map data.

17. The method of claim 16, wherein using the auto-curation time predictive model further includes dividing the map data into segments and adjusting two or more segments to change a set of auto-curation times associated with the two or more segments.

18. The method of claim 14, further comprising using a map deficiency model to determine map deficiencies based on the map data and an additional probe trace data estimate for correcting the map deficiencies.

19. The method of claim 18, further comprising determining a correction route based on the additional probe trace data estimate; and sending the correction route to a vehicle, wherein the correction route includes route instructions that configures the vehicle to implement the correction route.

20. The method of claim 18, further comprising obtaining additional probe data; and determining if map deficiencies have been resolved based on the additional probe data.
